(19) United States
(12) Patent Application Publication
(10) Pub. No.: US 2025/0341492 A1
(43) Pub. Date: Nov. 6, 2025

(54) Testing a Bond Between Two Components

(71) Applicant: The Boeing Company, Arlington, VA (US)

(72) Inventors: Steven K. Brady, Renton, WA (US); Joseph Daniel Schaefer, Richmond Heights, MO (US); Brian P. Justusson, St. Charles, MO (US)

(21) Appl. No.: 18/654,853

(22) Filed: May 3, 2024

(51) Int. Cl. G01N 29/04; G01N 29/44

(52) U.S. Cl. CPC G01N 29/045; G01N 29/4427; G01N 2291/0289

(57) ABSTRACT

Methods of inspection and of testing a strength of a bond between two components are presented. A laser bond inspection of a bonded assembly is performed, the bonded assembly comprising the two components joined by the bond. The bonded assembly is acoustically monitored during the laser bond inspection.

### BACKGROUND INFORMATION

### 1. Field

The present disclosure relates generally to bond inspection and testing more specifically to laser bond inspection techniques.

### 2. Background

Certification approaches for bonded assemblies include verification of structural strength. Certification can be achieved through development of alternative load paths, such as fasters, or through proof testing demonstrating the bond integrity throughout the bonded assembly. Unitized composite bonded assemblies reduce weight, non-recurring costs, and inspection requirements. However, it is undesirably difficult or infeasible to proof test most composite bonded assemblies.

Therefore, it would be desirable to have a method and apparatus that takes into account at least some of the issues discussed above, as well as other possible issues.

### SUMMARY

An embodiment of the present disclosure provides a laser bond inspection of a bonded assembly is performed, the bonded assembly comprising the two components joined by the bond. The bonded assembly is acoustically monitored during the laser bond inspection.

Another embodiment of the present disclosure provides a method of testing a bond. Laser energy is directed into the ablative material on a first surface of a bonded assembly comprising the bond to generate a compressive force and a subsequent tension wave in the bonded assembly. The bonded assembly is acoustically monitored to generate acoustic data as the compressive force and the tension wave travel through the bonded assembly. It is determined if a strength of the bond is sufficient using the acoustic data.

Yet another embodiment of the present disclosure provides a method of inspecting a bond. An ablative material is positioned on a first surface of a bonded assembly comprising the bond. Laser energy is directed into the ablative material to generate a compressive force and a subsequent tension wave in the bonded assembly. The bonded assembly is acoustically monitored during and after directing the laser energy into the ablative material to generate acoustic data. It is determined if the acoustic data indicates a disbond generated in the bond.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of an inspection environment in accordance with an illustrative embodiment;

FIG. 3 is an illustration of a schematic of inspecting a bond in a bonded assembly using a laser bond inspection method in accordance with an illustrative embodiment;

FIG. 4 is an illustration of a schematic of inspecting a bond in a bonded assembly using a laser bond inspection method in accordance with an illustrative embodiment;

FIG. 5 is an illustration of a schematic of inspecting a bond in a bonded assembly using a laser bond inspection method in accordance with an illustrative embodiment;

FIG. 6 is an illustration of a schematic of inspecting a bond in a bonded assembly using a laser bond inspection method in accordance with an illustrative embodiment;

FIG. 7 is an illustration of a schematic of inspecting a bond in a bonded assembly using a laser bond inspection method in accordance with an illustrative embodiment;

FIG. 8 is an illustration of a schematic of inspecting a bond in a bonded assembly using a laser bond inspection method in accordance with an illustrative embodiment;

FIG. 9 is a flowchart of a method of testing a strength of a bond between two components in accordance with an illustrative embodiment;

FIG. 10 is a flowchart of a method of testing a bond in accordance with an illustrative embodiment;

FIG. 11 is a flowchart of a method of inspecting a bond in accordance with an illustrative embodiment;

FIG. 12 is an illustration of an aircraft manufacturing and service method in a form of a block diagram in accordance with an illustrative embodiment; and

FIG. 13 is an illustration of an aircraft in a form of a block diagram in which an illustrative embodiment may be implemented.

### DETAILED DESCRIPTION

The illustrative examples recognize and take into account several considerations. The illustrative embodiments recognize and take into account that Laser Bond Inspection (LBI) is a bond testing technology. The illustrative embodiments recognize and take into account that current applications of LBI use a post-LBI non-destructive inspection (NDI) to determine if the bondline sustained damage during the LBI event. The illustrative embodiments recognize and take into account that NDI suffers from limitations such as difficulties in geometric features, resolution issues, and portability. The illustrative embodiments recognize and take into account that the NDI is a second step in the inspection process, which consumes additional time.

The illustrative examples provide a laser bond inspection technique without the use of post-LBI non-destructive inspection. The illustrative examples provide a laser bond inspection technique with reduced inspection time. The illustrative examples provide for acoustic emission (AE) sensors along the bonded assembly during the proof-test to record inaudible acoustic signals released during an LBI event that induces inconsistencies.

In the illustrative examples, the coupled measurement system allows for a damage event to be detected immediately from the LBI event. In some illustrative examples, the acoustic data generated can be compared to a characteristic acoustic signature for a damaging bondline. The illustrative examples eliminate the use of post-test NDI. The illustrative examples provide an alternative to conventional large structural proof testing.

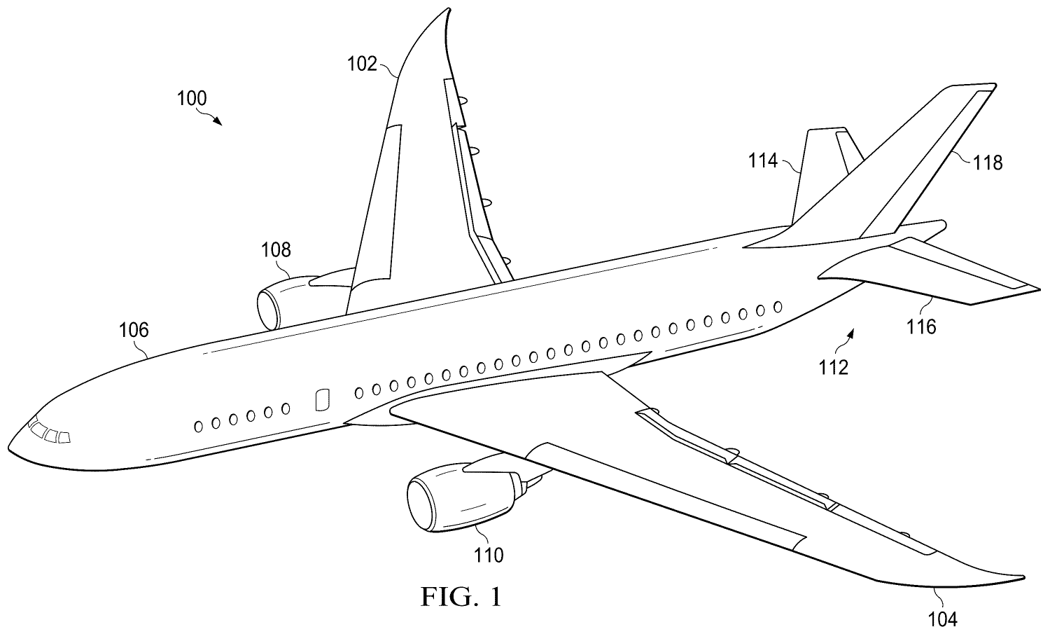

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have bonded assemblies inspected using the illustrative examples. For example, a strength of a bond of a bonded assembly of at least one of wing 102, wing 104, or body 106 can be tested using the illustrative examples.

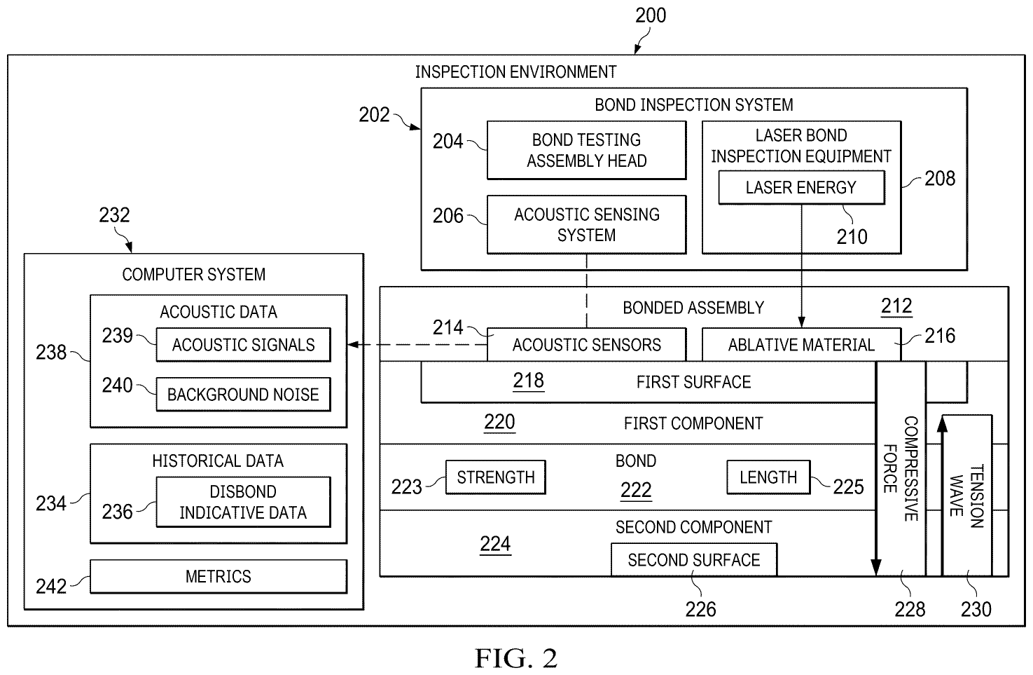

Turning now to FIG. 2, an illustration of a block diagram of a manufacturing environment is depicted in accordance with an illustrative embodiment. Bond 222 of bonded assembly 212 is inspected using bond inspection system 202 in inspection environment 200. In some illustrative examples, bonded assembly 212 is a component of aircraft 100 of FIG. 1.

Bonded assembly 212 comprises first component 220 bonded to second component 224 forming bond 222. First component 220 is formed of any desirable material. In some illustrative examples, first component 220 is one of a polymeric component, composite component, a metal component, or a ceramic component. As used herein, a composite is a fiber reinforced composite component. In some illustrative examples, the composite can be a fiber-reinforced resin or any other desirable type of thermoplastic polymer or thermoset polymer reinforced with fibers. First component 220 has any desirable design or structural feature. In some illustrative examples, first component 220 is a component comprising a honeycomb or core.

Second component 224 is formed of any desirable material. In some illustrative examples, second component 224 is one of a polymeric component, composite component, a metal component, or a ceramic component. As used herein, a composite is a fiber reinforced composite component. In some illustrative examples, the composite can be a fiber-reinforced resin or any other desirable type of thermoplastic polymer or thermoset polymer reinforced with fibers. Second component 224 has any desirable design or structural feature. In some illustrative examples, second component 224 is a component comprising a honeycomb or core.

Bond 222 takes any desirable form. In some illustrative examples, bond 222 comprises an adhesive. In some illustrative examples, bond 222 comprises at least one of adhesive, a co-cure, or a co-bond. Bond 222 can be formed by any desirable method. In some illustrative examples, bond 222 could be formed by application of adhesive, co-curing, co-bonding, cold spray, flame spray, welding, or any other desirable method.

Bonded assembly 212 has two surfaces, first surface 218 and second surface 226. Bond 222 is positioned between first surface 218 and second surface 226 but is not formed by first surface 218 and second surface 226. In this illustrative example, first surface 218 and second surface 226 are opposite surfaces.

Bond inspection system 202 comprises laser bond inspection equipment 208 and acoustic sensing system 206. Laser bond inspection equipment 208 is configured to send laser energy 210 into ablative material 216. Laser bond inspection equipment 208 is configured to send laser energy 210 into ablative material 216 that is sufficient to generate compressive force 228 in bonded assembly 212 beneath ablative material 216.

Acoustic sensing system 206 comprises acoustic sensors 214. In some illustrative examples, acoustic sensors 214 are coupled to at least one of first surface 218 or second surface 226. In some illustrative examples, acoustic sensors 214 can take the form of small microphone-like sensors that detect acoustic signals. Acoustic sensors 214 are removed from bonded assembly 212 after the test. Acoustic sensors 214 are not flyaway sensors. In some illustrative examples, acoustic sensors 214 can be adhered to at least one of first surface 218 or second surface 226. In some illustrative examples, acoustic sensors 214 are acoustically coupled to at least one of first surface 218 or second surface 226 by a non- adhesive material.

In some illustrative examples, acoustic sensors 214 are positioned along length 225 of bond 222. In some illustrative examples, acoustic sensors 214 are arranged in sets of sensors along length 225 of bond 222.

In some illustrative examples, acoustic sensors 214 are coupled to bonded assembly 212 independently of movement of laser bond inspection equipment 208. In these illustrative examples, acoustic sensors 214 are moved and placed relative to bonded assembly 212 independently of laser bond inspection equipment 208. In other illustrative examples, bond inspection system 202 comprises bond testing assembly head 204 comprising laser bond inspection equipment 208 and acoustic sensing system 206.

In some illustrative examples, bond testing assembly head 204 is positioned adjacent first surface 218 such that laser bond inspection equipment 208 in bond testing assembly head 204 is directed at first surface 218. In these illustrative examples, laser energy 210 is directed via bond testing assembly head 204. In these illustrative examples, bonded assembly 212 is acoustically monitored with acoustic sensors 214 in bond testing assembly head 204.

To test bond 222, laser bond inspection equipment 208 directs laser energy 210 into ablative material 216 on first surface 218 to generate compressive force 228 and subsequent tension wave 230 in bonded assembly 212. Laser energy 210 striking ablative material 216 generates compressive force 228 in bonded assembly 212 beneath ablative material 216. Compressive force 228 travels through bonded assembly 212. Compressive force 228 travels from first surface 218 through first component 220, bond 222, and second component 224. Tension wave 230 is generated when compressive force 228 reaches second surface 226. Tension wave 230 applies a force to bond 222. Tension wave 230 tests strength 223 of bond 222. If strength 223 is insufficient, tension wave 230 will generate an inconsistency in bond 222. If strength 223 is sufficient, bond 222 remains intact after tension wave 230 applies the force to bond 222.

As tension wave 230 applies the tension to bond 222, acoustic sensors 214 monitor bonded assembly 212 for signals signifying disbond of bond 222. Acoustic sensors 214 generate acoustic data 238 while monitoring bonded assembly 212.

Tension wave 230 generates noise when a disbond is created by tension wave 230. In some illustrative examples, bond 222 can include at least one of kissing bonds, weak bonds, or minor inconsistencies that can be disbonded by tension wave 230. When bond 222 is of a desirable strength, tension wave 230 will not generate a disbond in bond 222.

Acoustic data 238 is generated by acoustic sensors 214 as acoustic sensing system monitors bonded assembly 212. In this illustrative example, computer system 232 receives acoustic data 238 and can analyze acoustic data 238 to determine if an inconsistency has been formed in bond 222. In some illustrative examples, computer system 232 determines if strength 223 is sufficient. In some illustrative examples, computer system 232 determines if strength 223 of bond 222 is sufficient by comparing acoustic data 238 to disbond indicative data 236. In some illustrative examples, disbond indicative data 236 is historical data 234 for bonds that had inconsistencies generated by laser bond inspection. By comparing acoustic data 238 to disbond indicative data 236, at least one of the signal strength, the signal length, or a signal shape of acoustic data 238 is compared to disbond indicative data 236 to identify similarities.

In some illustrative examples, determining if the strength of bond 222 is sufficient comprises filtering out background noise 240 from acoustic data 238. By filtering out background noise 240 from acoustic data 238, signals indicative of inconsistencies are more easily identified.

Acoustic data 238 comprises acoustic signals 239 and background noise 240. Computer system 232 analyzes acoustic signals 239 generated during acoustic monitoring of bonded assembly 212. In some illustrative examples, analyzing acoustic signals 239 comprises comparing acoustic signals 239 to metrics 242. In some illustrative examples, at least one of a signal strength, a signal length, or other aspects of acoustic data 238 is compared against metrics 242.

The illustration of inspection environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, acoustic sensors 214 can be positioned relative to second surface 226. Acoustic sensors 214 can be coupled to second surface 226 to monitor bonded assembly 212.

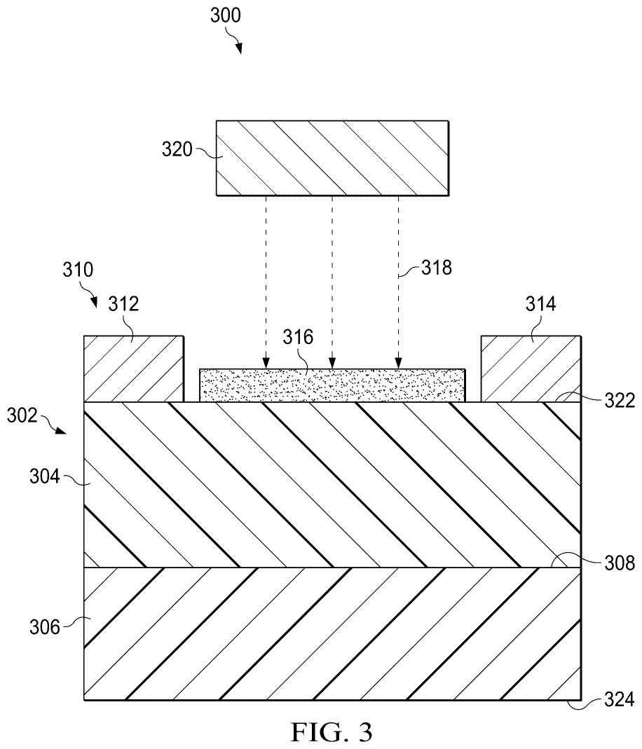

Turning now to FIG. 3, an illustration of a schematic of inspecting a bond in a bonded assembly using a laser bond inspection method is depicted in accordance with an illustrative embodiment. In view 300, laser bond inspection equipment 320 is positioned to inspect bonded assembly 302. Bonded assembly 302 is a physical implementation of bonded assembly 212 of FIG. 2. Laser bond inspection equipment 320 is a physical implementation of laser bond inspection equipment 208 of FIG. 2.

Bonded assembly 302 comprises first component 304 and second component 306 joined at bond 308. Bond 308 can be tested using laser bond inspection. The laser bond inspection can test the strength of bond 308 by applying forces to bond 308. In view 300, laser energy 318 is directed into ablative material 316. Laser energy 318 is sufficient to generate a compressive force in bonded assembly 302 beneath ablative material 316. The compressive force will travel from first surface 322 towards second surface 324 of bonded assembly 302.

Bonded assembly 302 is acoustically monitored during the laser bond inspection. Acoustic sensors 310 are in acoustic contact with first surface 322 of bonded assembly 302. In this illustrative example, monitoring bonded assembly 302 comprises acoustically monitoring from first surface 322. In this illustrative example, laser energy 318 is directed towards first surface 322 of bonded assembly 302. In some illustrative examples, acoustic sensors 310 can be adhered to first surface 322. In some illustrative examples, acoustic sensors 310 are acoustically coupled to first surface 322 by a non-adhesive material.

In this illustrative example, acoustic sensors 310 comprise sensor 312 and sensor 314. Sensor 312 and sensor 314 are positioned on opposite sides of ablative material 316.

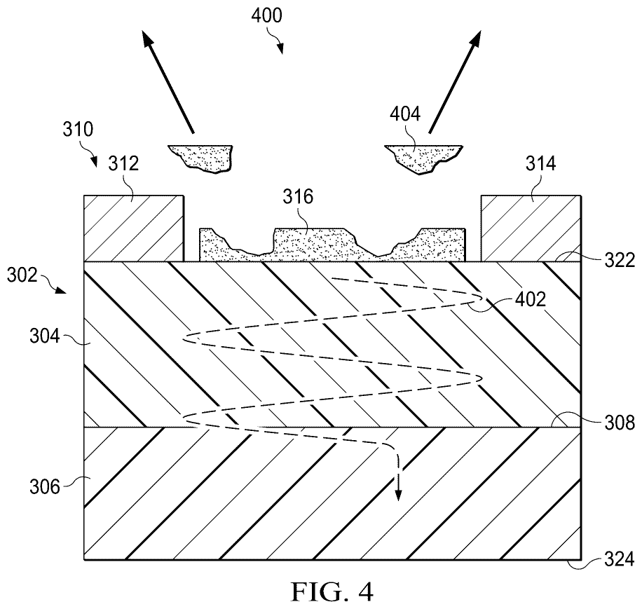

Turning now to FIG. 4, an illustration of a schematic of inspecting a bond in a bonded assembly using a laser bond inspection method is depicted in accordance with an illustrative embodiment. View 400 is a view of compressive force 402 propagating through bonded assembly 302. Compressive force 402 is generated by laser energy 318 breaking fragments 404 from ablative material 316. Compressive force 402 begins at first surface 322 and travels through bond 308 to second surface 324.

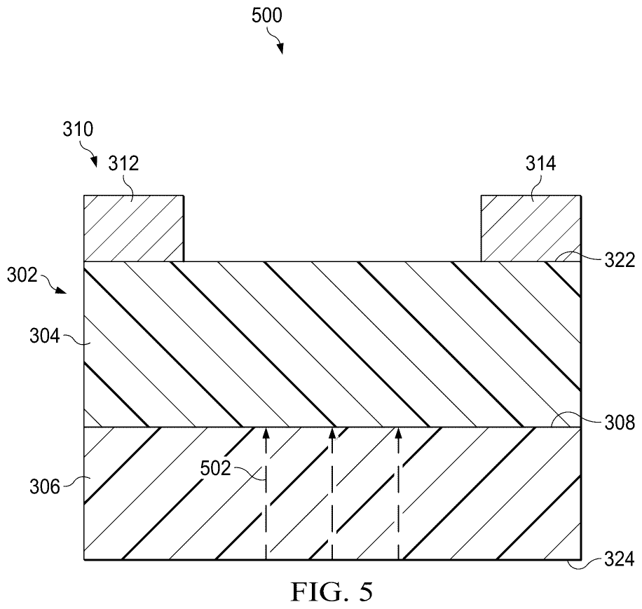

Turning now to FIG. 5, an illustration of a schematic of inspecting a bond in a bonded assembly using a laser bond inspection method is depicted in accordance with an illustrative embodiment. In view 500, compressive force 402 of FIG. 4 has reached second surface 324. After compressive force 402 of FIG. 4 reaches second surface 324, tension wave 502 is generated as a result. Tension wave 502 applies a force to bond 308 that can pull apart bonds with undesirably low strength. Tension wave 502 applies a force to test the strength of bond 308.

As tension wave 502 applies the tension to bond 308, acoustic sensors 310 monitor bonded assembly 302 for signals signifying disbond of bond 308.

Tension wave 502 generates noise when a disbond is created by tension wave 502. In some illustrative examples, bond 308 can include at least one of kissing bonds, weak bonds, or minor inconsistencies that can be disbonded by tension wave 502. When bond 308 is of a desirable strength, tension wave 502 will not generate a disbond in bond 308.

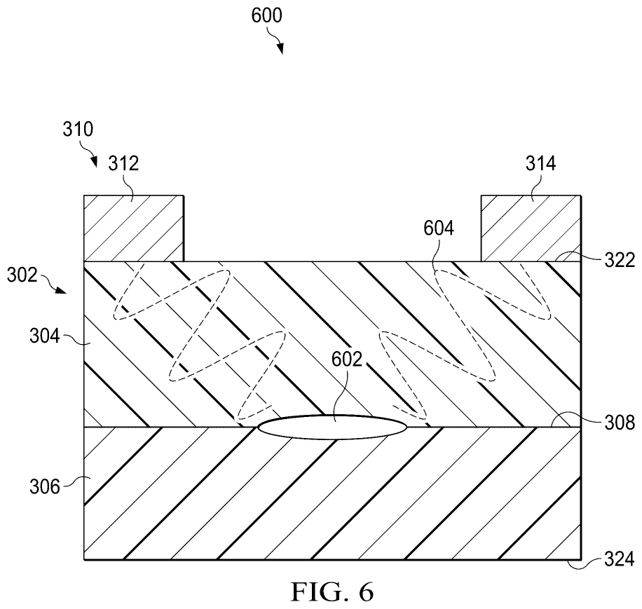

Turning now to FIG. 6, an illustration of a schematic of inspecting a bond in a bonded assembly using a laser bond inspection method is depicted in accordance with an illustrative embodiment. In view 600, disbond 602 is generated in response to tension wave 502 of FIG. 5. Noise 604 is generated from generation of disbond 602 created by tension wave 502. Noise 604 is detected by acoustic sensors 310. Acoustic data generated by acoustic sensors 310 can be compared to disbond indicative data.

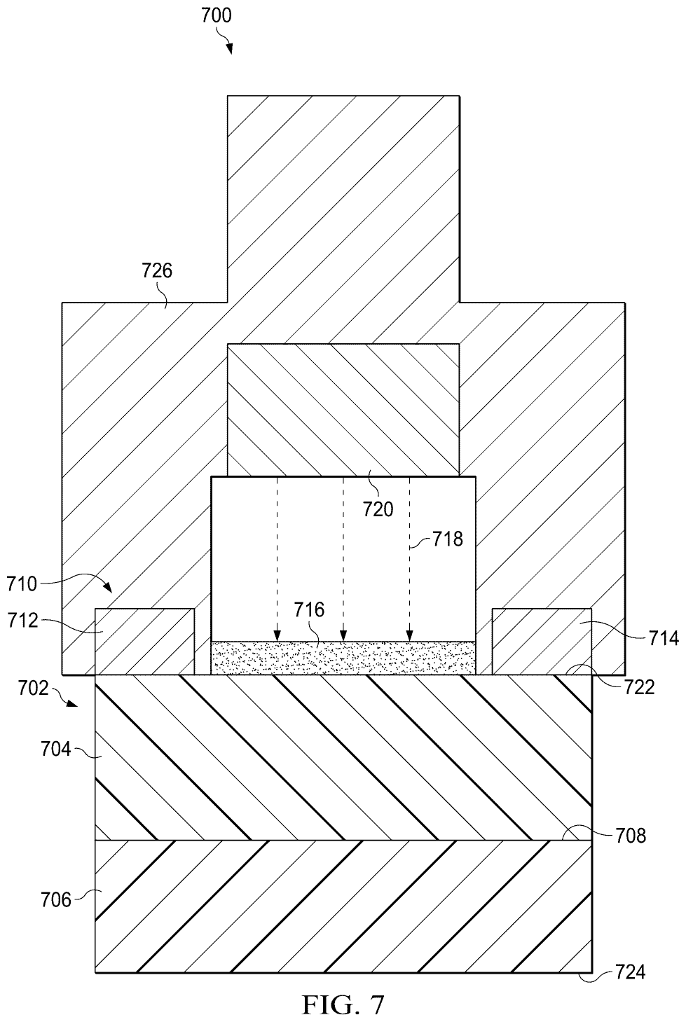

Turning now to FIG. 7, an illustration of a schematic of inspecting a bond in a bonded assembly using a laser bond inspection method is depicted in accordance with an illustrative embodiment. In view 700, laser bond inspection equipment 720 is positioned to inspect bonded assembly 702. Bonded assembly 702 is a physical implementation of bonded assembly 212 of FIG. 2. Laser bond inspection equipment 720 is a physical implementation of laser bond inspection equipment 208 of FIG. 2.

Bonded assembly 702 comprises first component 704 and second component 706 joined at bond 708. Bond 708 can be tested using laser bond inspection. The laser bond inspection can test the strength of bond 708 by applying forces to bond 708. In view 700, laser energy 718 is directed into ablative material 716. Laser energy 718 is sufficient to generate a compressive force in bonded assembly 702 beneath ablative material 716. The compressive force will travel from first surface 722 towards second surface 724 of bonded assembly 702.

Bonded assembly 702 is acoustically monitored during the laser bond inspection. Acoustic sensors 710 are in acoustic contact with first surface 722 of bonded assembly 702. In this illustrative example, monitoring bonded assembly 702 comprises acoustically monitoring from first surface 722. In this illustrative example, laser energy 718 is directed towards first surface 722 of bonded assembly 702.

In this illustrative example, acoustic sensors 710 comprise sensor 712 and sensor 714. Sensor 712 and sensor 714 are positioned on opposite sides of ablative material 716. In this illustrative example, acoustic sensors 710 are held within bond testing assembly head 726.

Bond testing assembly head 726 is positioned adjacent first surface 722 such that laser bond inspection equipment 720 in bond testing assembly head 726 is directed at the first surface 722. Laser energy 718 is directed via bond testing assembly head 726. Acoustically monitoring bonded assembly 702 comprises acoustically monitoring bonded assembly 702 with acoustic sensors 710 in bond testing assembly head 726.

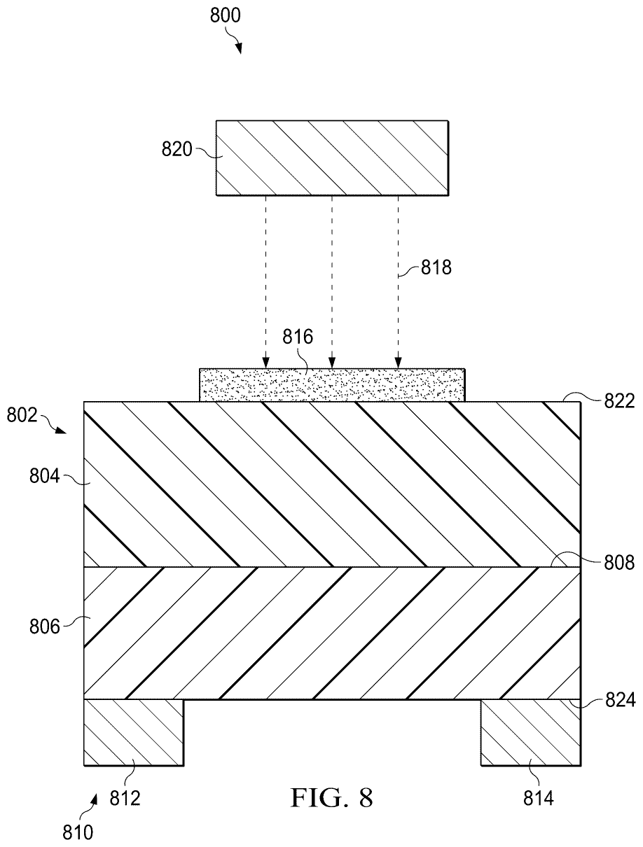

Turning now to FIG. 8, an illustration of a schematic of inspecting a bond in a bonded assembly using a laser bond inspection method is depicted in accordance with an illustrative embodiment. In view 800, laser bond inspection equipment 820 is positioned to inspect bonded assembly 802. Bonded assembly 802 is a physical implementation of bonded assembly 212 of FIG. 2. Laser bond inspection equipment 820 is a physical implementation of laser bond inspection equipment 208 of FIG. 2.

Bonded assembly 802 comprises first component 804 and second component 806 joined at bond 808. Bond 808 can be tested using laser bond inspection. The laser bond inspection can test the strength of bond 808 by applying forces to bond 808. In view 800, laser energy 818 is directed into ablative material 816. Laser energy 818 is sufficient to generate a compressive force in bonded assembly 802 beneath ablative material 816. The compressive force will travel from first surface 822 towards second surface 824 of bonded assembly 802.

Bonded assembly 802 is acoustically monitored during the laser bond inspection. Acoustic sensors 810 are in acoustic contact with second surface 824 of bonded assembly 802. In this illustrative example, monitoring bonded assembly 802 comprises acoustically monitoring from second surface 824. In this illustrative example, laser energy 818 is directed towards first surface 822 of bonded assembly 802. In some illustrative examples, acoustic sensors 810 can be adhered to second surface 824. In some illustrative examples, acoustic sensors 810 are acoustically coupled to second surface 824 by a non-adhesive material.

In this illustrative example, acoustic sensors 810 comprise sensor 812 and sensor 814. Acoustic sensors 810 can comprise any desirable quantity of sensors.

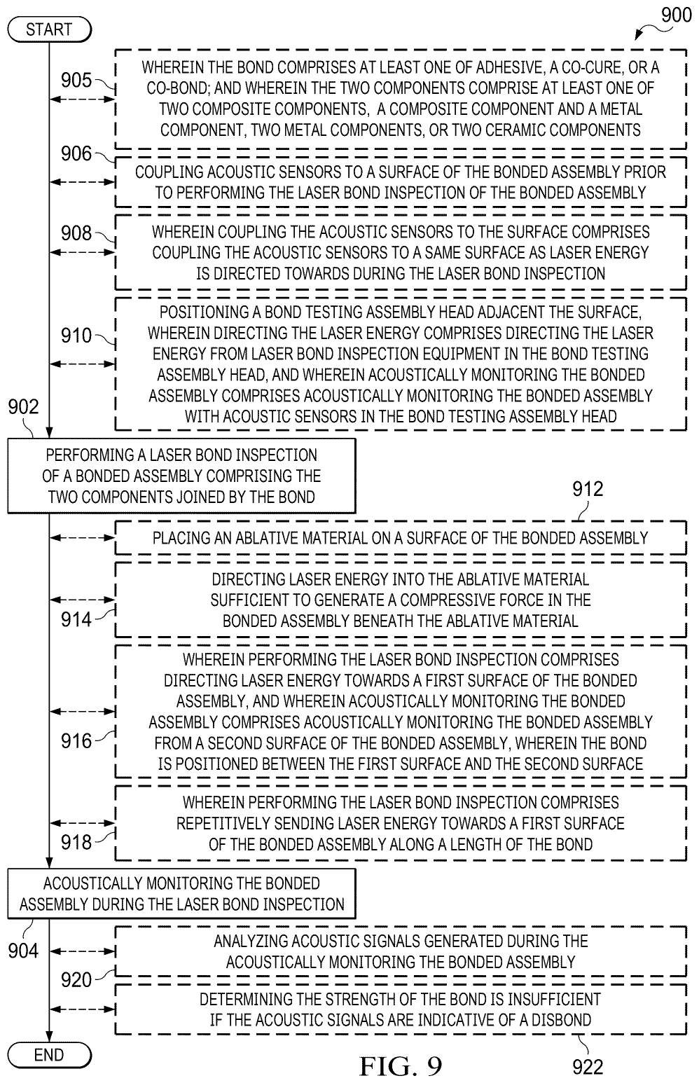

Turning now to FIG. 9, a flowchart of a method of testing a strength of a bond between two components is depicted in accordance with an illustrative embodiment. Method 900 can be performed to test a strength of a bond in a component of aircraft 100 of FIG. 1. Method 900 can be performed to test strength 223 of bond 222 in bonded assembly 212. Method 900 can be performed on bonded assembly 302 on FIGS. 3-6. Method 900 can be performed on bonded assembly 702 of FIG. 7. Method 900 can be performed on bonded assembly 802 of FIG. 8.

Method 900 performs a laser bond inspection of a bonded assembly comprising the two components joined by the bond (operation 902). Method 900 acoustically monitors the bonded assembly during the laser bond inspection (operation 904). Afterwards, method 900 terminates.

In some illustrative examples, the bond comprises at least one of adhesive, a co-cure, or a co-bond; and wherein the two components comprise at least one of two composite components, a composite component and a metal component, two metal components, or two ceramic components (operation 905). Each of the two components has any desirable structural design. In some illustrative examples, at least one of the two components comprises a honeycomb or a core.

In some illustrative examples, method 900 couples acoustic sensors to a surface of the bonded assembly prior to performing the laser bond inspection of the bonded assembly (operation 906). In some illustrative examples, the acoustic sensors can be adhered to the surface. In some illustrative examples, the acoustic sensors are acoustically coupled to the surface by a non-adhesive material.

In some illustrative examples, coupling the acoustic sensors to the surface comprises coupling the acoustic sensors to a same surface as laser energy is directed towards during the laser bond inspection (operation 908). In these illustrative examples, the laser bond inspection can be performed on bonded assemblies with access to only a single surface. In some illustrative examples, the laser bond inspection can be performed on bonded assemblies with limited access.

In some illustrative examples, method 900 positions a bond testing assembly head adjacent the surface, wherein directing the laser energy comprises directing the laser energy from laser bond inspection equipment in the bond testing assembly head, and wherein acoustically monitoring the bonded assembly comprises acoustically monitoring the bonded assembly with acoustic sensors in the bond testing assembly head (operation 910). In these illustrative examples, the acoustic sensors and the laser bond inspection equipment are moved along the bonded assembly together.

In some illustrative examples, performing the laser bond inspection comprises placing an ablative material on a surface of the bonded assembly (operation 912), and directing laser energy into the ablative material sufficient to generate a compressive force in the bonded assembly beneath the ablative material (operation 914). In some illustrative examples, the laser energy sent into the ablative material is sufficient to fragment the ablative material.

In some illustrative examples, performing the laser bond inspection comprises directing laser energy towards a first surface of the bonded assembly, and wherein acoustically monitoring the bonded assembly comprises acoustically monitoring the bonded assembly from a second surface of the bonded assembly, wherein the bond is positioned between the first surface and the second surface (operation 916). In these illustrative examples, the bonded assembly is accessible from multiple sides.

In some illustrative examples, performing the laser bond inspection comprises repetitively sending laser energy towards a first surface of the bonded assembly along a length of the bond (operation 918). By repetitively sending laser energy towards the bonded assembly, the bond can be inspected along its length.

In some illustrative examples, method 900 analyzes acoustic signals generated during the acoustically monitoring the bonded assembly (operation 920). In some illustrative examples, analyzing the acoustic signals comprises comparing the acoustic signals to metrics. In some illustrative examples, analyzing the acoustic signals comprises comparing the acoustic signals to disbond indicative data. In some illustrative examples, analyzing the acoustic signals comprises measuring at least one of a signal strength or a signal length. In some illustrative examples, method 900 determines the strength of the bond is insufficient if the acoustic signals are indicative of a disbond (operation 922).

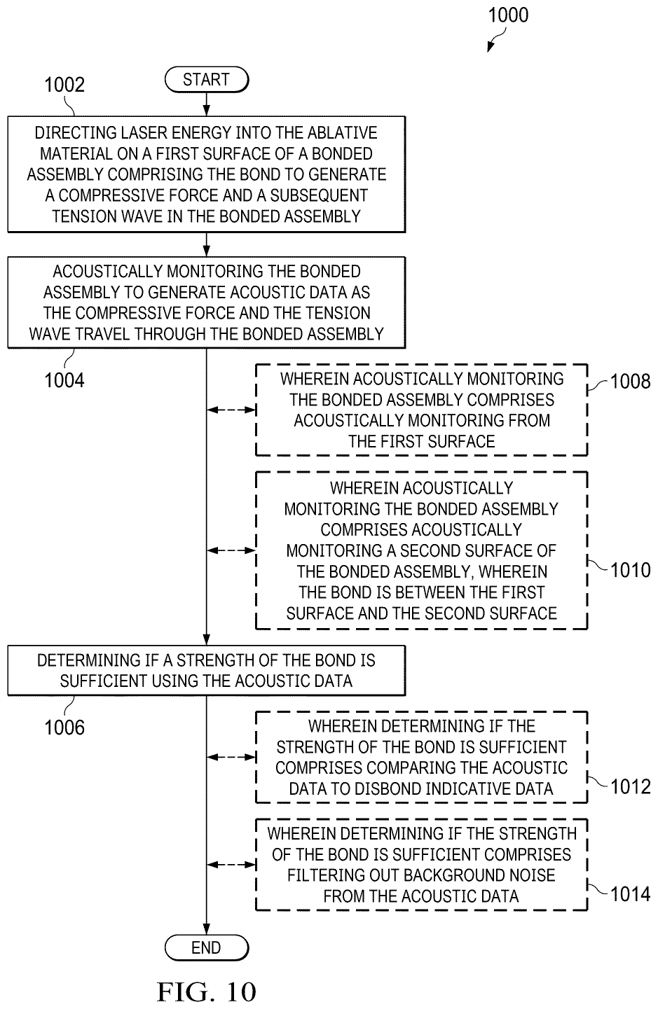

Turning now to FIG. 10, a flowchart of a method of testing a bond is depicted in accordance with an illustrative embodiment. Method 1000 can be performed to test a bond in a component of aircraft 100 of FIG. 1. Method 1000 can be performed to test bond 222 in bonded assembly 212. Method 1000 can be performed on bonded assembly 302 on FIGS. 3-6 to test bond 308. Method 1000 can be performed on bonded assembly 702 of FIG. 7 to test bond 708. Method 1000 can be performed on bonded assembly 802 of FIG. 8 to test bond 808.

Method 1000 directs laser energy into the ablative material on a first surface of a bonded assembly comprising the bond to generate a compressive force and a subsequent tension wave in the bonded assembly (operation 1002). Method 1000 acoustically monitors the bonded assembly to generate acoustic data as the compressive force and the tension wave travel through the bonded assembly (operation 1004). Method 1000 determines if a strength of the bond is sufficient using the acoustic data (operation 1006). Afterwards, method 1000 terminates.

In some illustrative examples, acoustically monitoring the bonded assembly comprises acoustically monitoring from the first surface (operation 1008). In these illustrative examples, the laser bond inspection can be performed on bonded assemblies with access to only a single surface. In some illustrative examples, the laser bond inspection can be performed on bonded assemblies with limited access.

In some illustrative examples, acoustically monitoring the bonded assembly comprises acoustically monitoring a second surface of the bonded assembly, wherein the bond is between the first surface and the second surface (operation 1010). In these illustrative examples, at least two surfaces of the bonded assembly can be accessed.

In some illustrative examples, determining if the strength of the bond is sufficient comprises comparing the acoustic data to disbond indicative data (operation 1012). In some illustrative examples, the disbond indicative data is historical data. In some illustrative examples, at least one of the signal strength, the signal length, or a signal shape of the acoustic data is compared to the disbond indicative data to identify similarities.

In some illustrative examples, determining if the strength of the bond is sufficient comprises filtering out background noise from the acoustic data (operation 1014). By filtering out background noise from the acoustic data, signals indicative of inconsistencies are more easily identified.

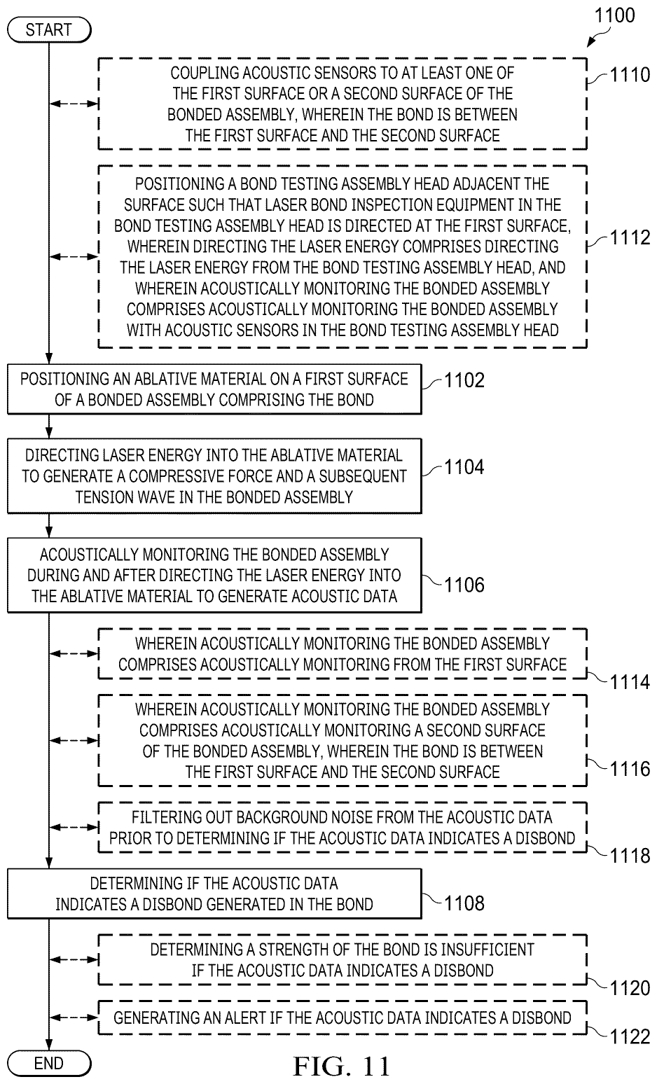

Turning now to FIG. 11, a flowchart of a method of inspecting a bond is depicted in accordance with an illustrative embodiment. Method 1100 can be performed to test a bond in a component of aircraft 100 of FIG. 1. Method 1100 can be performed to test bond 222 in bonded assembly 212. Method 1100 can be performed on bonded assembly 302 on FIGS. 3-6 to test bond 308. Method 1100 can be performed on bonded assembly 702 of FIG. 7 to test bond 708. Method 1100 can be performed on bonded assembly 802 of FIG. 8 to test bond 808.

Method 1100 positions an ablative material on a first surface of a bonded assembly comprising the bond (operation 1102). Method 1100 directs laser energy into the ablative material to generate a compressive force and a subsequent tension wave in the bonded assembly (operation 1104). Method 1100 acoustically monitors the bonded assembly during and after directing the laser energy into the ablative material to generate acoustic data (operation 1106). Method 1100 determines if the acoustic data indicates a disbond generated in the bond (operation 1108). Afterwards, method 1100 terminates.

In some illustrative examples, method 1100 couples acoustic sensors to at least one of the first surface or a second surface of the bonded assembly, wherein the bond is between the first surface and the second surface (operation 1110).

In some illustrative examples, method 1100 positions a bond testing assembly head adjacent the first surface such that laser bond inspection equipment in the bond testing assembly head is directed at the first surface, wherein directing the laser energy comprises directing the laser energy from the bond testing assembly head, and wherein acoustically monitoring the bonded assembly comprises acoustically monitoring the bonded assembly with acoustic sensors in the bond testing assembly head (operation 1112). In these illustrative examples, the acoustic sensors move along with the laser bond inspection equipment relative to the bonded assembly.

In some illustrative examples, acoustically monitoring the bonded assembly comprises acoustically monitoring from the first surface (operation 1114). In these illustrative examples, the laser bond inspection can be performed on bonded assemblies with access to only a single surface. In some illustrative examples, the acoustic sensors and the laser bond inspection equipment are moved together in a bond testing assembly head when laser bond inspection and acoustic monitoring are performed on a single surface.

In some illustrative examples, acoustically monitoring the bonded assembly comprises acoustically monitoring a second surface of the bonded assembly, wherein the bond is between the first surface and the second surface (operation 1116). In these illustrative examples, laser bond inspection is performed by accessing two different surfaces of the bonded assembly.

In some illustrative examples, method 1100 filters out background noise from the acoustic data prior to determining if the acoustic data indicates a disbond (operation 1118). By filtering out background noise from the acoustic data, signals indicative of inconsistencies are more easily identified.

In some illustrative examples, method 1100 determines a strength of the bond is insufficient if the acoustic data indicates a disbond (operation 1120). In some illustrative examples, the acoustic data is evaluated based on metrics to determine whether the acoustic data indicates a disbond. In some illustrative examples, at least one of a signal strength, a signal length, or other aspects of the acoustic data is compared against metrics. In some illustrative examples, the acoustic data is compared to historical data including disbond indicative data. In some illustrative examples, method 1100 generates an alert if the acoustic data indicates a disbond (operation 1122).

As used herein, the phrase “at least one of,” when used with a list of items, means different combinations of one or more of the listed items may be used and only one of each item in the list may be needed. For example, “at least one of item A, item B, or item C,” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 905 through operation 922 may be optional. As another example, operation 1008 through operation 1014 may be optional. Additionally, operation 1110 through operation 1122 may be optional.

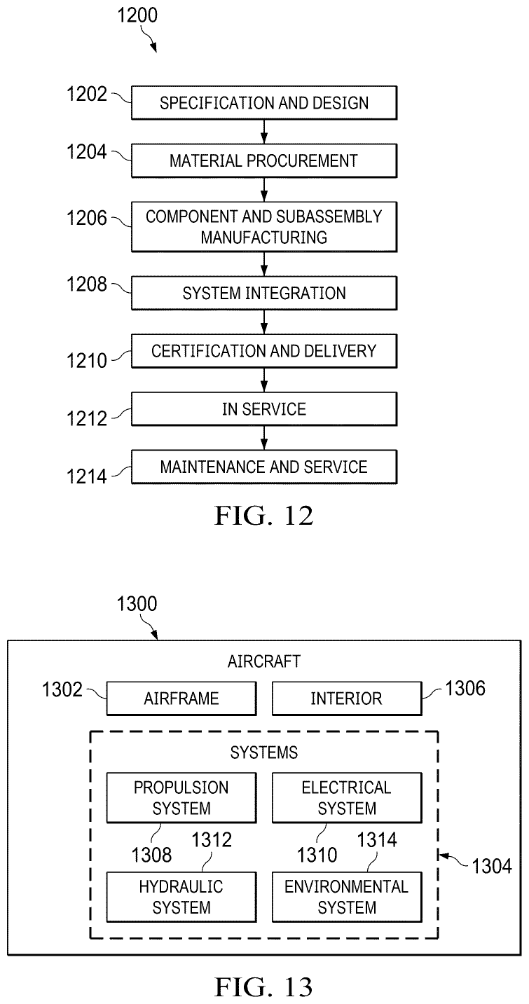

Illustrative embodiments of the present disclosure may be described in the context of aircraft manufacturing and service method 1200 as shown in FIG. 12 and aircraft 1300 as shown in FIG. 13. Turning first to FIG. 12, an illustration of an aircraft manufacturing and service method in a form of a block diagram is depicted in accordance with an illustrative embodiment. During pre-production, aircraft manufacturing and service method 1200 may include specification and design 1202 of aircraft 1300 in FIG. 13 and material procurement 1204.

During production, component and subassembly manufacturing 1206 and system integration 1208 of aircraft 1300 takes place. Thereafter, aircraft 1300 may go through certification and delivery 1210 in order to be placed in service 1212. While in service 1212 by a customer, aircraft 1300 is scheduled for routine maintenance and service 1214, which may include modification, reconfiguration, refurbishment, or other maintenance and service.

Each of the processes of aircraft manufacturing and service method 1200 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 13, an illustration of an aircraft in a form of a block diagram is depicted in which an illustrative embodiment may be implemented. In this example, aircraft 1300 is produced by aircraft manufacturing and service method 1200 of FIG. 12 and may include airframe 1302 with plurality of systems 1304 and interior 1306. Examples of systems 1304 include one or more of propulsion system 1308, electrical system 1310, hydraulic system 1312, and environmental system 1314. Any number of other systems may be included.

Apparatuses and methods embodied herein may be employed during at least one of the stages of aircraft manufacturing and service method 1200. One or more illustrative embodiments may be manufactured or used during at least one of component and subassembly manufacturing 1206, system integration 1208, in service 1212, or maintenance and service 1214 of FIG. 12.

The illustrative examples provide a bond inspection system with a technical capability that induces a controlled tensile wave into a specimen to proof-test a bond. In some illustrative examples the bond inspection system is a laser bond inspection system. The illustrative examples comprise acoustic emission sensors. The illustrative examples comprise a classifier to characterize the acoustic emissions.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of testing a strength of a bond between two components comprising:
performing a laser bond inspection of a bonded assembly comprising the two components joined by the bond; and
acoustically monitoring the bonded assembly during the laser bond inspection.

2. The method of claim 1 further comprising:
analyzing acoustic signals generated during the acoustically monitoring the bonded assembly; and
determining the strength of the bond is insufficient if the acoustic signals are indicative of a disbond.

3. The method of claim 1 further comprising:
coupling acoustic sensors to a surface of the bonded assembly prior to performing the laser bond inspection of the bonded assembly.

4. The method of claim 3, wherein coupling the acoustic sensors to the surface comprises coupling the acoustic sensors to a same surface as laser energy is directed towards during the laser bond inspection.

5. The method of claim 1, wherein performing the laser bond inspection comprises:
placing an ablative material on a surface of the bonded assembly; and
directing laser energy into the ablative material sufficient to generate a compressive force in the bonded assembly beneath the ablative material.

6. The method of claim 5 further comprising:
positioning a bond testing assembly head adjacent the surface, wherein directing the laser energy comprises directing the laser energy from laser bond inspection equipment in the bond testing assembly head, and wherein acoustically monitoring the bonded assembly comprises acoustically monitoring the bonded assembly with acoustic sensors in the bond testing assembly head.

7. The method of claim 1, wherein performing the laser bond inspection comprises directing laser energy towards a first surface of the bonded assembly, and wherein acoustically monitoring the bonded assembly comprises acoustically monitoring the bonded assembly from a second surface of the bonded assembly, wherein the bond is positioned between the first surface and the second surface.

8. The method of claim 1, wherein performing the laser bond inspection comprises repetitively sending laser energy toward a first surface of the bonded assembly along a length of the bond.

9. The method of claim 1, wherein the bond comprises at least one of adhesive, a co-cure, or a co-bond; and wherein the two components comprise at least one of two composite components, a composite component and a metal component, two metal components, or two ceramic components.

10. A method of testing a bond comprising:
directing laser energy into an ablative material on a first surface of a bonded assembly comprising the bond to generate a compressive force and a subsequent tension wave in the bonded assembly;
acoustically monitoring the bonded assembly to generate acoustic data as the compressive force and the tension wave travel through the bonded assembly; and
determining if a strength of the bond is sufficient using the acoustic data.

11. The method of claim 10, wherein determining if the strength of the bond is sufficient comprises comparing the acoustic data to disbond indicative data.

12. The method of claim 10, wherein determining if the strength of the bond is sufficient comprises filtering out background noise from the acoustic data.

13. The method of claim 10, wherein acoustically monitoring the bonded assembly comprises acoustically monitoring from the first surface.

14. The method of claim 10, wherein acoustically monitoring the bonded assembly comprises acoustically monitoring a second surface of the bonded assembly, wherein the bond is between the first surface and the second surface.

15. A method of inspecting a bond comprising:
positioning an ablative material on a first surface of a bonded assembly comprising the bond;
directing laser energy into the ablative material to generate a compressive force and a subsequent tension wave in the bonded assembly;
acoustically monitoring the bonded assembly during and after directing the laser energy into the ablative material to generate acoustic data; and
determining if the acoustic data indicates a disbond generated in the bond.

16. The method of claim 15, wherein acoustically monitoring the bonded assembly comprises acoustically monitoring from the first surface.

17. The method of claim 15, wherein acoustically monitoring the bonded assembly comprises acoustically monitoring a second surface of the bonded assembly, wherein the bond is between the first surface and the second surface.

18. The method of claim 15 further comprising:
coupling acoustic sensors to at least one of the first surface or a second surface of the bonded assembly, wherein the bond is between the first surface and the second surface.

19. The method of claim 15 further comprising:
positioning a bond testing assembly head adjacent the first surface such that laser bond inspection equipment in the bond testing assembly head is directed at the first surface, wherein directing the laser energy comprises directing the laser energy from the bond testing assembly head, and wherein acoustically monitoring the bonded assembly comprises acoustically monitoring the bonded assembly with acoustic sensors in the bond testing assembly head.

20. The method of claim 15 further comprising:
determining a strength of the bond is insufficient if the acoustic data indicates a disbond.

21. The method of claim 15 further comprising:
generating an alert if the acoustic data indicates a disbond.

22. The method of claim 15 further comprising:
filtering out background noise from the acoustic data prior to determining if the acoustic data indicates a disbond.
